(19) United States
(12) Patent Application Publication
(10) Pub. No.: US 2011/0004623 A1
(43) Pub. Date: Jan. 6, 2011

(54) WEB PAGE RELAY APPARATUS

(76) Inventors: Takahiro Sagara, Ebina (JP); Yoshiteru Takeshima, Tokyo (JP); Naokazu Nemoto, Kawasaki (JP)

Correspondence Address: MCDERMOTT WILL & EMERY LLP, 600 13TH STREET, N.W., WASHINGTON, DC, 20005-3096, US

(21) Appl. No.: 12/826,262

(22) Filed: Jun. 29, 2010

(30) Foreign Application Priority Data
Jun. 30, 2009 (JP) 2009-154544

(51) Int. Cl. G06F 15/16; G06F 17/00; G06F 17/30

(52) U.S. Cl. 707/770; 709/219; 715/205; 707/E17.014; 707/E17.032

(57) ABSTRACT

To inform a terminal whether linked URLs contained in a browsed Web page are subject to browsing restriction, without placing a high load on a URL information database, a relay apparatus acquires a Web page from a Web server in accordance with a request from a terminal, queries a URL database as to a linked URL contained in the Web page, creates link information containing a restriction level to which a linked Web page belongs and the in-page location of a link display, determines a link subject to browsing restriction based on the link information and a predetermined restriction level of the requesting terminal, changes the link display, and sends the Web page with the changed link display to the terminal. Further, the relay apparatus caches the link information. If link information about a Web page acquired in accordance with a request from the terminal exists in a cache, the relay apparatus does not query URL information but uses the link information.

### INCORPORATION BY REFERENCE

This application claims priority based on a Japanese patent application, No. 2009-154544 filed on Jun. 30, 2009, the entire contents of which are incorporated herein by reference.

### BACKGROUND

The present invention relates to a server or a relay apparatus disposed in a communication path between a terminal and a server in a network system for communicating data between the server and the terminal such as WWW (World Wide Web).

Mobile phones are now in widespread use due to the convenience thereof, and parents often buy and provide them for their children. Many mobile phones of these days have Web browsing capability, which enables the browsing of various Web sites on the Internet and the use of contents through mobile phones. However, there exist on the Internet many Web sites containing information harmful to children's education and security such as sites showing pornography and dating websites. Further, it is difficult to monitor and restrict Web site browsing from mobile terminals such as mobile phones.

For this reason, there is required means for controlling access to sites on the Internet from mobile phones and other terminals to restrict the browsing of specific Web sites.

For example, according to a method described in Japanese Patent Application Laid-Open No. 2003-50758, identification information is provided to a terminal, an access permission level is established, and a management site for storing the level of the terminal and a Uniform Resource Locator (hereinafter referred to as URL), subject to access restriction, corresponding to the level is provided beforehand on the Internet, so that when the terminal accesses a site on the Internet, browsing is restricted based on the URL of the site and the level of the terminal.

### SUMMARY

In many cases, information (called a link) for referring to a file such as another document or image or another Web page is inserted into a Web page, and displayed as a link display in a selectable manner. In Web site browsing, a user selects a link display in a Web page, thereby to move to a referred-to (linked) Web page. However, in Japanese Patent Application Laid-Open No. 2003-50758, a browsing restriction determination is made on an access-requested URL; therefore, whether the linked Web page is subject to browsing restriction cannot be determined until the user actually selects the link display.

Therefore, it is not until the user selects the link display to browse the Web page and then receives a response of browsing restriction that the user recognizes that the linked Web page is under browsing restriction. This leads to interruption of Web page browsing, which impairs the user's convenience. Further, despite unintended access, it may be taken as an attempt of unauthorized access, leading to disadvantage for the user.

Disclosed is a Web page display method of determining whether or not a linked URL contained in a requested Web page is subject to browsing restriction in accordance with the attribute (e.g., level) of a requesting terminal or a requester before the display of the Web page and displaying the Web page along with a determination result on the terminal.

According to the Web page display method, it is determined whether a linked URL contained in a Web page is subject to browsing restriction, and the Web page to which determination result information is added is displayed on the terminal.

The determination result information may be, for example, information for changing the color of a link display subject to browsing restriction. By the display based on the determination result information, the user can recognize which link is under browsing restriction before selecting the link.

Further, whether a URL is subject to browsing restriction may be determined by providing and querying a site (URL management site) for managing a database for storing URLs subject to browsing restriction or URLs not subject to browsing restriction. The queried URL management site searches a URL information database to check whether the queried URL is subject to browsing restriction or is not subject to browsing restriction (this processing is referred to as look-up processing), and sends a result.

The above processing may be performed by a Web page relay apparatus provided on a network between the terminal and a Web server.

Some Web pages contain quite a few links, which may place a large load on the URL management site. Further, the load of string retrieval for extracting links in a Web page may become excessive.

To reduce the load on the URL management site, by the relay apparatus, information about linked URLs contained in each Web page may be created for each Web page, stored in a memory, and used to determine whether a linked URL is subject to browsing restriction. This information is referred to as link information, and indicates, for example, the in-page location of each link contained in a Web page and the attribute (e.g., level) of browsing restriction on each link.

If link information corresponding to a Web page requested by the terminal exists in the memory, the relay apparatus can determine, based on the link information about the page stored in the memory and the attribute of the requesting terminal, whether the linked URL is subject to browsing restriction, without querying the URL management site. This can reduce the load on the URL management site.

The Web page display method includes a transmission step of transmitting a Web page request to the server; a reception step of receiving the Web page from the server; an extraction step of extracting a linked URL contained in the received Web page; a determination step of determining, based on a browsing restriction attribute of a linked Web page indicated by the extracted linked URL and terminal attribute information contained in the request, whether or not the linked Web page is subject to browsing restriction; a creation step of creating a determined Web page with a determination result reflected in a link display corresponding to the linked URL in the received Web page; and a display step of displaying the determined Web page on the terminal, as a response to the Web page request.

Further, a relay apparatus may be provided on a network between the terminal and the Web server, and perform the reception step, the extraction step, the determination step, and the creation step, and the terminal may perform the transmission step and the display step.

Further, the relay apparatus may perform a link information creation step of creating link information indicating a location of the linked URL in the Web page from which the linked URL is extracted in the extraction step and the browsing restriction attribute of the linked Web page, and a link information storage step of storing the link information in association with an identifier for identifying the Web page from which the linked URL is extracted.

Further, the relay apparatus may include a communication relay unit for relaying a Web page request from the terminal to the server and receiving the Web page from the server; a link extraction unit for extracting a linked URL contained in the Web page received from the server; a URL information look-up unit for querying a URL information database for managing a browsing restriction attribute of a Web page, as to a browsing restriction attribute of a linked Web page indicated by the extracted linked URL; a link information creation unit for creating link information indicating a location of the linked URL in the received Web page and the browsing restriction attribute of the linked Web page indicated by the linked URL based on the browsing restriction attribute acquired by the URL information look-up unit and the received Web page; a terminal information look-up unit for extracting terminal identification information contained in the Web page request received from the terminal and querying a terminal information database for managing a combination of terminal identification information and terminal attribute information, as to a terminal attribute corresponding to the terminal identification information; and a browsing restriction determination unit for determining, based on the terminal attribute information acquired by the terminal information look-up unit and the link information, whether the linked Web page indicated in the received Web page is subject to browsing restriction on the terminal.

Further, the browsing restriction determination unit may have a content change unit for creating a determined Web page with a change in an attribute of a link display corresponding to a linked URL determined to be subject to browsing restriction, and the communication relay unit may transmit to the terminal the determined Web page created by the content change unit instead of the Web page acquired from the server.

According to the teaching herein, it is possible to inform the user beforehand whether links contained in a Web page are subject to browsing restriction, without placing a high load on the URL information database.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a block diagram of a relay apparatus according to a first embodiment;

FIG. 2 is a block diagram of an information processing apparatus used as the relay apparatus according to the first embodiment;

FIG. 3A is a configuration example of terminal information stored in a storage device according to the first embodiment;

FIG. 3B is a configuration example of URL information stored in a storage device according to the first embodiment;

FIG. 3C is a configuration example of link information stored in a storage device according to the first embodiment;

FIG. 4 is a flowchart for processing a request which the relay apparatus according to the first embodiment receives from a terminal;

FIG. 5 is a block diagram of a relay apparatus according to a second embodiment;

FIG. 6A is a configuration example of terminal information stored in a storage device according to a third embodiment;

FIG. 6B is a configuration example of URL information stored in a storage device according to the third embodiment;

FIG. 6C is a configuration example of link information stored in a storage device according to the third embodiment;

FIG. 7 is a configuration example of terminal information stored in a storage device according to a fourth embodiment;

FIG. 8 is a block diagram of a relay apparatus according to a fifth embodiment;

FIG. 9 is a block diagram of a relay apparatus according to a sixth embodiment;

FIG. 10 is a block diagram of a relay apparatus according to a seventh embodiment;

FIG. 11 is a part of a flowchart for processing a request which the relay apparatus according to the seventh embodiment receives from the terminal; and

FIG. 12 is a flowchart for processing a request for link information which the relay apparatus according to the seventh embodiment receives from another relay apparatus.

### DETAILED DESCRIPTION OF THE EMBODIMENTS

Hereinafter, embodiments of the present invention will be described with reference to the accompanying drawings.

In the following embodiments, a relay apparatus disposed on a network has a browsing restriction determination function; however, a Web server may have the browsing restriction determination function.

Further, in the following embodiments, one relay apparatus on the network has the browsing restriction determination function; however, the processing units and storage units of the browsing restriction determination function may be separated to physically different devices coupled via the network.

### First Embodiment

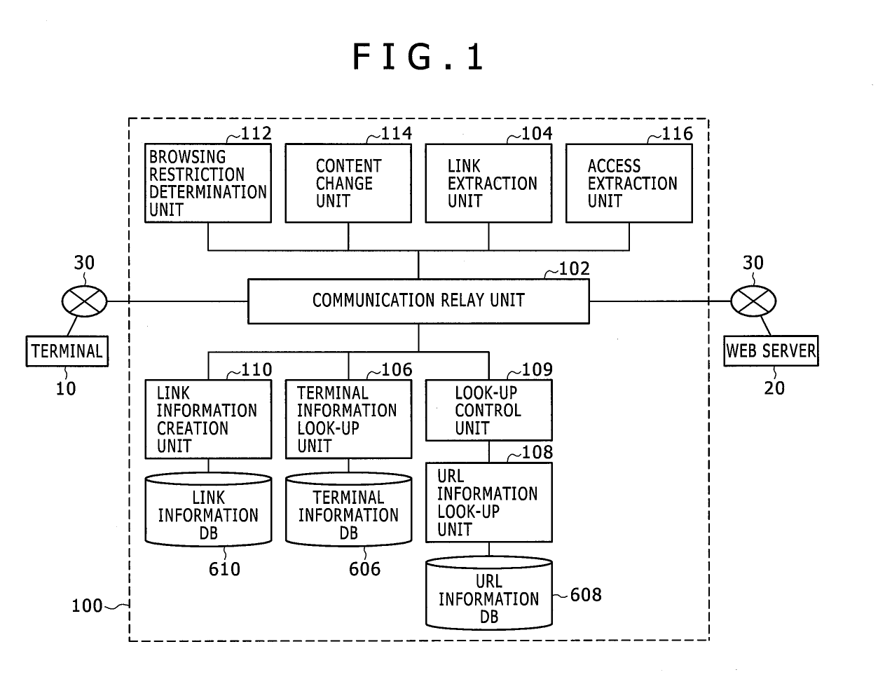

As shown in FIG. 1, a communication system according to this embodiment includes a terminal 10 which requests a Web page, using a communication protocol (e.g., Hyper Text Transfer Protocol (hereinafter referred to as HTTP)) for acquiring a Web page (described, e.g., in Hyper Text Markup Language (hereinafter referred to as HTML)) from a server; a Web server 20 which sends the Web page to the terminal, using the communication protocol; and a relay apparatus 100 which performs communication relay and control through a network 30 such as the Internet between the terminal 10 and the Web server 20. The communication system may include a plurality of terminals 10, Web servers 20, and relay apparatuses 100.

In the relay apparatus 100 shown in FIG. 1, a communication relay unit 102 receives a request from the terminal 10 to the Web server 20, relays the request to the Web server 20, receives from the Web server 20 a response to the request, and relays the response to the terminal 10.

A terminal information DB 606 is a storage unit for storing a pair of terminal identification information (e.g., terminal serial number on a mobile phone) registered beforehand and a terminal attribute such as a level.

A terminal information look-up unit 106 extracts terminal identification information (e.g., contained in a User-Agent header in HTTP) contained in a request from the terminal 10 and queries the terminal information DB 606, using the identification information as a key, thereby to acquire a level corresponding to the identification information registered beforehand.

A link extraction unit 104 extracts the URL of a link (e.g., anchor tag in HTML) to another Web page contained in a Web page acquired from the Web server 20 by the communication relay unit 102. The URL is a symbol sequence for specifying the location of an information resource, and is expressed, for example, in the form of “http://host name/path name” in HTTP.

A URL information DB 608 is a database (referred to as DB) for storing a pair of the URL of a Web page registered beforehand and the browsing restriction level of the Web page.

A URL information look-up unit 108 queries the URL information DB 608 as to the browsing restriction attribute (e.g., level at which access is restricted) of a Web page indicated by a URL extracted by the link extraction unit 104, and acquires the level. In the case where a plurality of extracted URLs are equal completely or partially such as in a domain name, the URL information look-up unit 108 may have a query function representatively using one of them.

A look-up control unit 109 determines whether the URL information look-up unit 108 queries the URL information DB 608 to control a query.

Based on a Web page acquired from the Web server 20 by the communication relay unit 102 and the level of a linked URL in the Web page acquired by the URL information look-up unit 108, a link information creation unit 110 creates link information describing the level of the link in the Web page. Further, the link information creation unit 110 caches the created link information into a link information DB 610.

A browsing restriction determination unit 112 determines, based on the link information cached by the link information creation unit 110 and the level of a requesting terminal acquired by the terminal information look-up unit 106, whether the link is subject to browsing restriction.

The content change unit 114 changes, deletes, or adds information as to the display of a link subject to browsing restriction determined by the browsing restriction determination unit 112, thus creating a determined Web page. Such a change is, for example, the change of an attribute such as the color of the link and/or the link background by adding a style attribute to an anchor element in HTML, or the addition of a unique attribute that the terminal 10 can interpret.

The relay apparatus 100 may include an access extraction unit 116 to restrict browsing when the terminal 10 requests direct access to a Web page subject to browsing restriction without following a link from a Web page. When the communication relay unit 102 receives a Web page acquisition request from the terminal 10, the access extraction unit 116 extracts the URL of the requested Web page. For example, in HTTP, the URL of the requested Web page is contained in a request line. The URL information look-up unit 108 acquires the level of the extracted URL, and the terminal information look-up unit 106 acquires the level of the requesting terminal. If the browsing restriction determination unit 112 determines from these pieces of information that the Web page is subject to browsing restriction, the communication relay unit 102 sends an error response or a prepared specific page in response to the request from the terminal 10.

The above method of restricting the browsing of an access-requested Web page without following a link from a Web page can be achieved by a known technique.

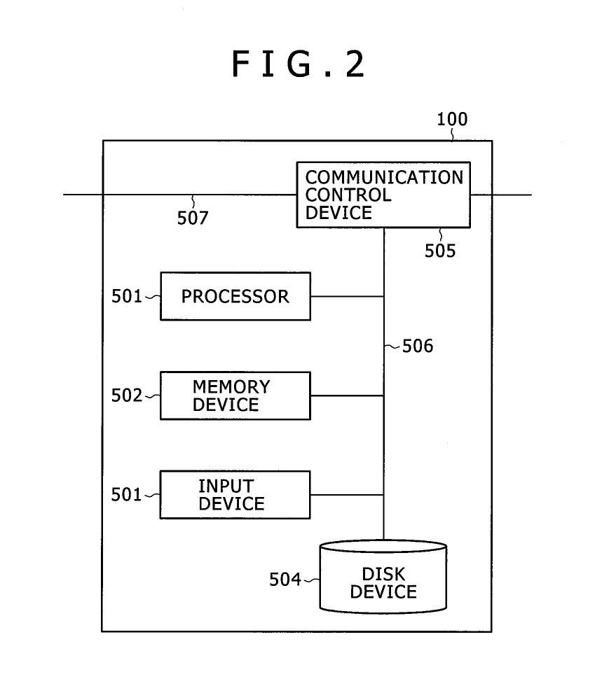

FIG. 2 is a diagram showing the physical configuration of a computer which achieves the relay apparatus 100 according to this embodiment. The relay apparatus 100 according to this embodiment includes a processor 501 for executing programs and implementing processing units described below; a memory device 502 for temporarily storing a program to be executed and data; an input device 503 for inputting an instruction and information from outside; a disk device 504, used as data storage means, for storing program entities, instructions, information, and the like; a communication control device 505 for controlling the exchange of data between internal and external devices of the relay apparatus 100; an internal communication line 506 such as a bus for exchanging data within the relay apparatus 100; and an external communication line 507 for exchanging data between internal and external devices of the relay apparatus 100.

The program may be stored beforehand in the memory device 502 or the disk device 504 in the relay apparatus 100, or may be installed from a removable storage medium that the relay apparatus 100 can use or from another device through a communication medium (a network, or a carrier wave or a digital signal that propagates through a network) when needed.

Further, each processing described below is implemented when the processor 501 reads and executes a program stored in the disk device 504.

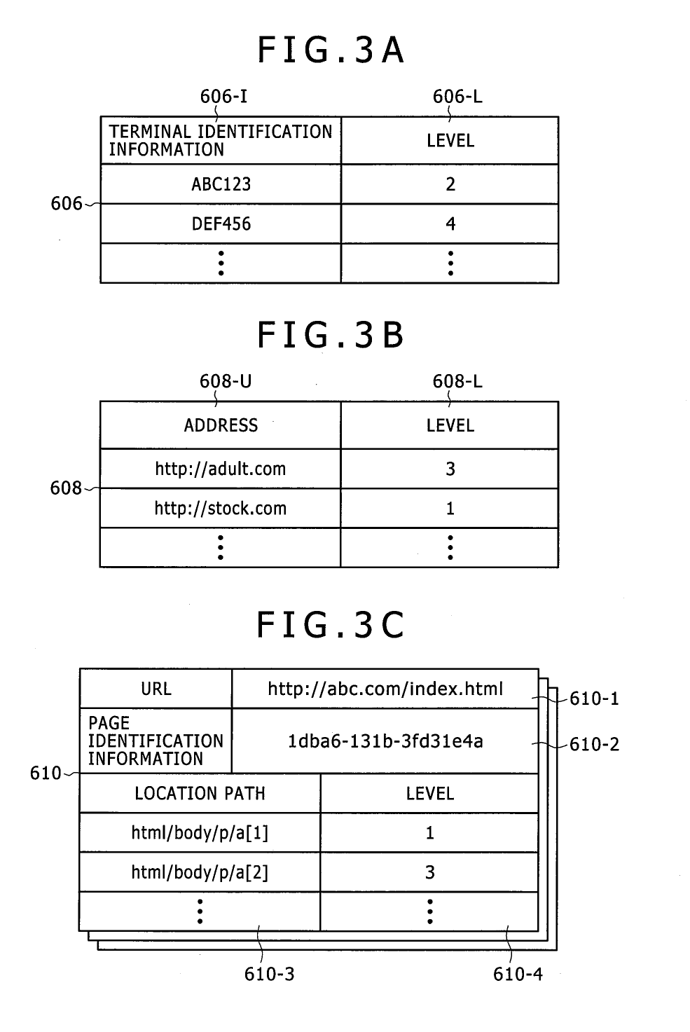

FIG. 3A is an example of the terminal information DB 606. The terminal information DB 606 has a terminal identification information DB 606-I for uniquely identifying a terminal and a level 606-L corresponding to the terminal, as entries.

FIG. 3B is an example of the URL information DB 608. The URL information DB 608 has an address 608-U indicating a URL and a level 608-L indicating the browsing restriction level of the URL, as entries. The terminal information DB 606 and the URL information DB 608 are also used in a conventional technique, and management such as update of each information can be achieved by a known technique.

FIG. 3C is an example of the link information DB 610. The link information DB 610 has a page location 610-1 indicating the URL of a Web page, a page identification information DB 610-2 for identifying the Web page, a location path 610-3 indicating the appearance location of a link in the Web page, and a level 610-4 indicating the link of the location path, as entries. The link information DB 610 may have a plurality of pairs of location paths 610-3 and levels 610-4. The location path 610-3 is described using, for example, XPath and the byte offset value of the link appearance location from a Web page start.

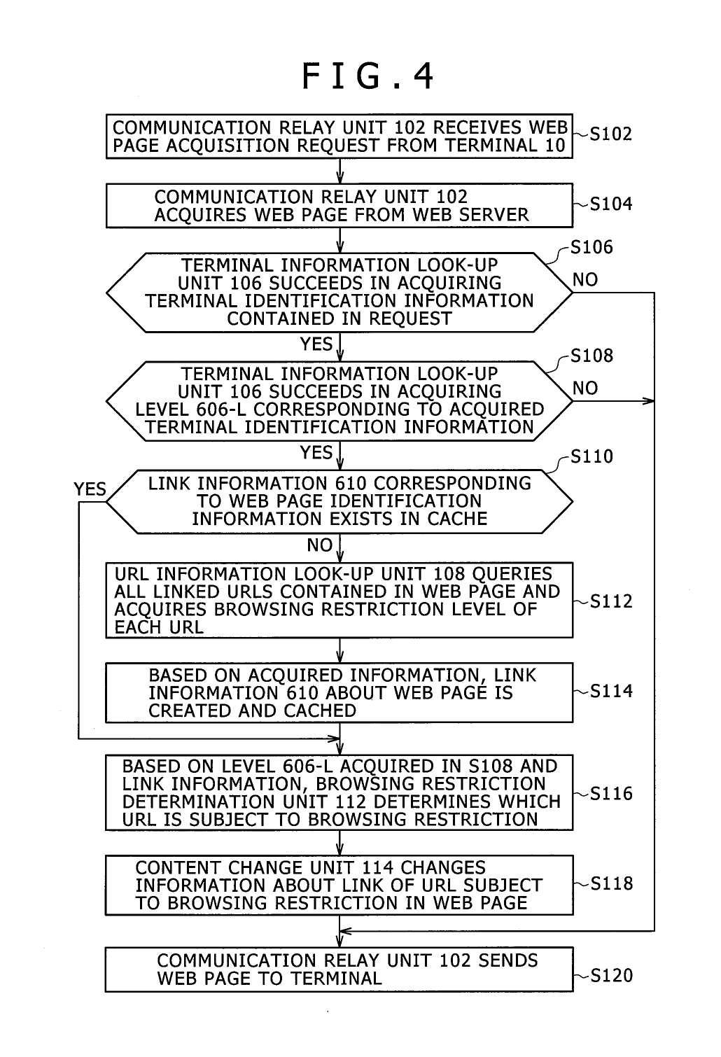

FIG. 4 is a flowchart showing operations when the communication relay unit 102 of the relay apparatus 100 receives a Web page acquisition request from the terminal 10.

First, the communication relay unit 102 of the relay apparatus 100 receives a Web page acquisition request from the terminal 10 (S102), and acquires the Web page from the Web server 20 based on the request (S104). Then, the terminal information look-up unit 106 acquires terminal identification information (e.g., contained in a User-Agent header) which the request has (S106), and acquires a level corresponding to the identification information from the terminal information DB 606 (S108). If the terminal information look-up unit 106 fails to acquire the identification information (NO in S106), or fails to perform look-up processing (NO in S108) because the identification information is not registered in the terminal information DB 606, the communication relay unit 102 sends the acquired Web page to the terminal as it is (S120). Further, the steps from S106 to S108 may be executed concurrently without waiting for a response from the Web server.

Then, the look-up control unit 109 determines whether the link information DB 610 having the page identification information DB 610-2 equal to identification information (e.g., the value of an Etag header contained in a response from the Web server) about the acquired Web page exists in a cache (S110). If the link information DB 610 having the page identification information DB 610-2 does not exist in the cache (NO in S110), the link extraction unit 104 extracts all linked URLs contained in the Web page, and the URL information look-up unit 108 acquires from the URL information DB 608 the browsing restriction level 608-L of each extracted URL (S112). If the link information DB 610 exists in the cache (YES in S110), the look-up control unit 109 suppresses the extraction of linked URLs and queries as to the URLs, and uses the link information DB 610 existing in the cache in the subsequent steps (from S116).

If NO in S110, the link information creation unit 110 creates and caches the link information DB 610, using the URL of the Web page, the identification information about the Web page, and the level 608-L of each URL in the Web page (S114).

Then, based on the terminal level 606-L and the link information DB 610, the browsing restriction determination unit 112 determines which URL is subject to browsing restriction (S116). For example, the browsing restriction determination unit 112 determines that a URL located in a location path 610-3 having a level 610-4 greater than the terminal level 606-L is subject to browsing restriction. In response thereto, the content change unit 114 adds, modifies, or deletes information as to the link of the URL subject to browsing restriction in the Web page (S118). Lastly, the communication relay unit 102 sends the Web page changed by the content change unit 114 to the terminal 10 (S120).

Thus, according to this embodiment, in response to a Web page acquisition request from the terminal, the relay apparatus can send to the terminal a Web page to which information about whether links in the Web page are subject to browsing restriction is added, without placing a high load on the URL information database.

### Second Embodiment

In the second embodiment, a relay apparatus creates Web page identification information, so that even if a response from the Web server does not contain page identification information, a browsing restriction determination function can be provided.

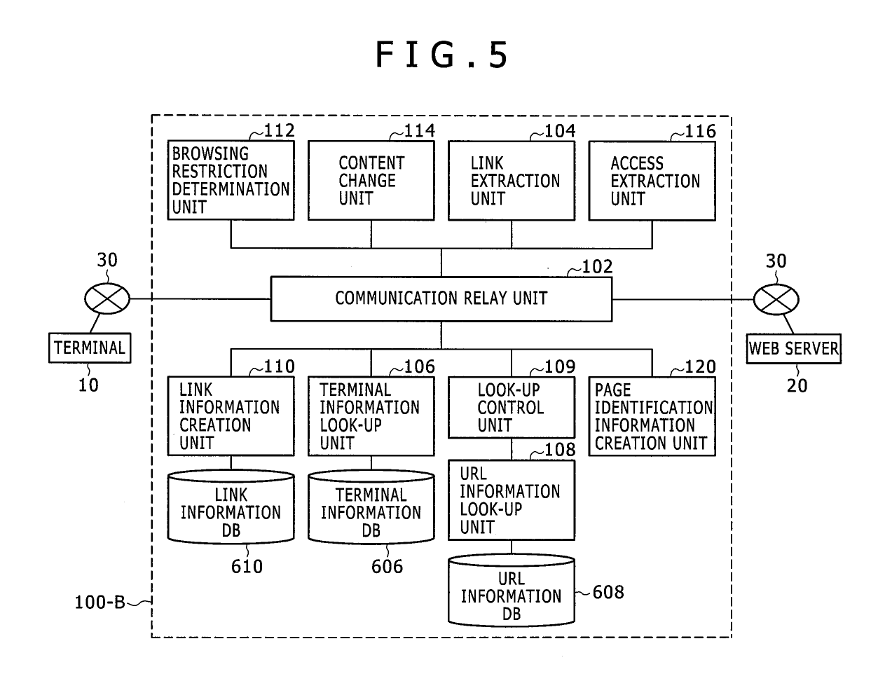

FIG. 5 shows a configuration example of a communication system according to the second embodiment. A relay apparatus 100-B includes a page identification information creation unit 120 for creating page identification information from Web page data. The other configurations are the same as in FIG. 1 in the first embodiment.

An operational flow according to this embodiment will be described. When the communication relay unit 102 acquires a Web page from the Web server 20 (S104 in the first embodiment), the page identification information creation unit 120 inputs the Web page data to a hash function (e.g., Message Digest 5), thereby obtaining the data of page identification information. In this embodiment, instead of S114 in the first embodiment, the link information creation unit 110 creates the link information DB 610, using the page identification information created by the page identification information creation unit 120. In this embodiment, in S118 in the first embodiment, if a link does not exist at a location indicated by the location path 610-3 of the link information DB 610, for example, because the link information creation unit 110 queries an incorrect link information DB 610 due to page identification information overlap caused by hash value collision, it is determined that the link information is incorrect, and the steps from S112 are executed. The other operations are the same as in FIG. 4 in the first embodiment.

Thus, according to this embodiment, even if a response from the Web server does not contain page identification information, the relay apparatus can send to the terminal a Web page to which information about whether links in the Web page are subject to browsing restriction is added, without placing a high load on the URL information database.

### Third Embodiment

In the third embodiment, a category to which a linked Web page belongs is used instead of a level to determine whether the linked Web page is subject to browsing restriction.

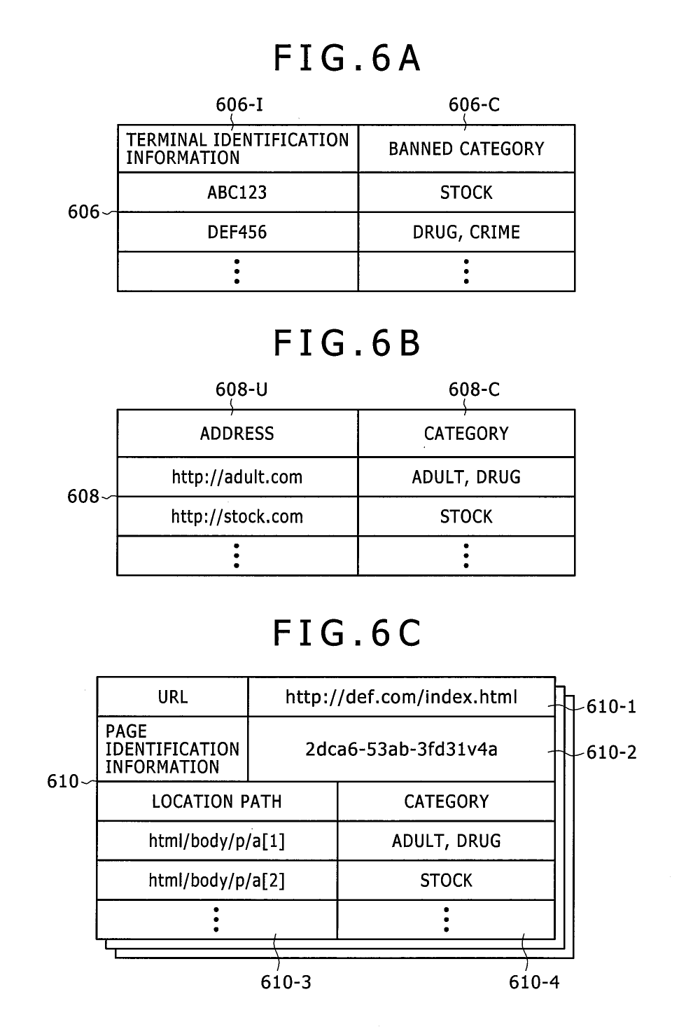

FIG. 6A is an example of the terminal information DB 606 according to this embodiment. The terminal information DB 606 has, as an entry, a banned category 606-C instead of the level 606-L in the first embodiment. The banned category 606-C is registered beforehand from among certain categories (e.g., drug, crime, stock, adult), and a plurality of banned categories 606-C may be registered for one terminal identification information DB 606-I.

FIG. 6B is an example of the URL information DB 608 according to this embodiment.

The URL information DB 608 has, as an entry, a category 608-C to which a URL belongs, instead of the level 608-L in the first embodiment. The category 608-C is registered beforehand from among certain categories, and a plurality of categories 608-C may be registered for one address 608-U.

FIG. 6C is an example of the link information DB 610 according to this embodiment. The link information DB 610 has, as an entry, a category 610-C to which a URL indicated by the location path 610-3 belongs, instead of the level 610-4 in the first embodiment. A plurality of categories 610-C may be registered for one location path 610-3.

A configuration example of a communication system is the same as in FIG. 1 in the first embodiment.

An operational flow according to this embodiment will be described. In this embodiment, the banned category 606-C, the category 608-C, and the category 610-C are used instead of the level 606-L, the level 608-L, and the level 610-4 in the first embodiment, respectively. Instead of S116 in the first embodiment, the browsing restriction determination unit 112 determines that the URL of a location path 610-3 containing at least one banned category 606-C of the terminal in a category 610-C is subject to browsing restriction. The other operations are the same as in FIG. 4 in the first embodiment.

Thus, according to this embodiment, even if browsing is restricted based on the banned category registered by a user, the relay apparatus can send to the terminal a Web page to which information about whether links in the Web page are subject to browsing restriction is added, without placing a high load on the URL information database.

Further, this embodiment can be combined with the first to second embodiments.

### Fourth Embodiment

In the fourth embodiment, a terminal level corresponding to the current time is used to determine whether a linked Web page is subject to browsing restriction.

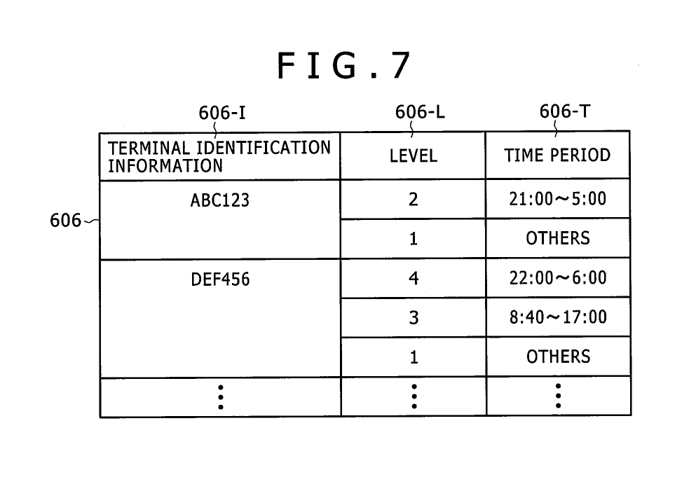

FIG. 7 is an example of the terminal information DB 606 according to this embodiment. The terminal information DB 606 has a time period 606-T indicating a time period during which a level is applied, in addition to the entries in the first embodiment. One terminal identification information DB 606-I may have a plurality of pairs of levels 606-L and time periods 606-T. Time periods 606-T, registered beforehand, cover 24 hours without overlapping each other in one terminal identification information DB 606-I.

An operational flow according to this embodiment will be described. Instead of S108 in the first embodiment, the terminal information look-up unit 106 acquires the current time in addition to terminal identification information contained in a request received by the communication relay unit 102. The terminal information look-up unit 106 acquires a level 606-L that has a terminal identification information DB 606-I equal to the acquired terminal identification information and corresponds to a time period 606-T including the current time. The other operations are the same as in FIG. 4 in the first embodiment.

Thus, according to this embodiment, even in the case where the browsing restriction level of the terminal changes depending on time (in the case of strict browsing restriction at night and loose restriction in the daytime), the relay apparatus can send to the terminal a Web page to which information about whether links in the Web page are subject to browsing restriction is added, without placing a high load on the URL information database.

Further, this embodiment can be combined with the first to third embodiments.

### Fifth Embodiment

In the fifth embodiment, if a linked URL in a Web page matches (or does not match) a URL pattern registered beforehand in a whitelist (or blacklist), the URL information look-up of the URL is suppressed.

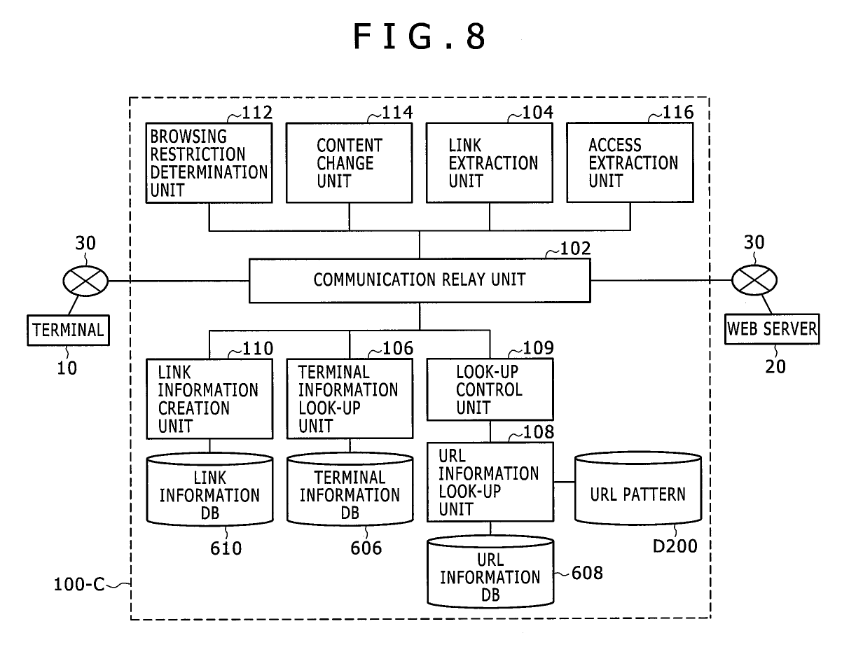

FIG. 8 shows a configuration example of a communication system according to the fifth embodiment. A relay apparatus 100-C includes a URL pattern D200 for storing at least one URL pattern registered beforehand. For example, the URL pattern is described like “*.ga.jp”, “*.xls”, using a wild card. The other configurations are the same as in FIG. 1 in the first embodiment.

An operational flow according to this embodiment will be described. Instead of S112 in the first embodiment, the look-up control unit 109 suppresses querying the URL information DB 608 as to a URL that matches any of the URL patterns D200 (or URL that does not match any of the URL patterns D200) among URLs extracted by the link extraction unit 104. The URL that has undergone the suppression of querying the URL information DB 608 is not subject to browsing restriction. The other operations are the same as in FIG. 4 in the first embodiment.

Thus, according to this embodiment, linked URLs not subject to browsing restriction are specified beforehand in a whitelist, and linked URLs subject to browsing restriction are specified beforehand in a blacklist, so that the relay apparatus can send to the terminal a Web page to which information about whether links in the Web page are subject to browsing restriction is added, while further suppressing a load on the URL information database.

Further, this embodiment can be combined with the first to fourth embodiments.

### Sixth Embodiment

In the sixth embodiment, when a relay apparatus sends to the terminal a Web page containing links changed based on a determination result, a link through which the terminal acquire an original unchanged Web page having links is contained in a response Web page having links, so that the selection of the link enables the acquisition of the original Web page.

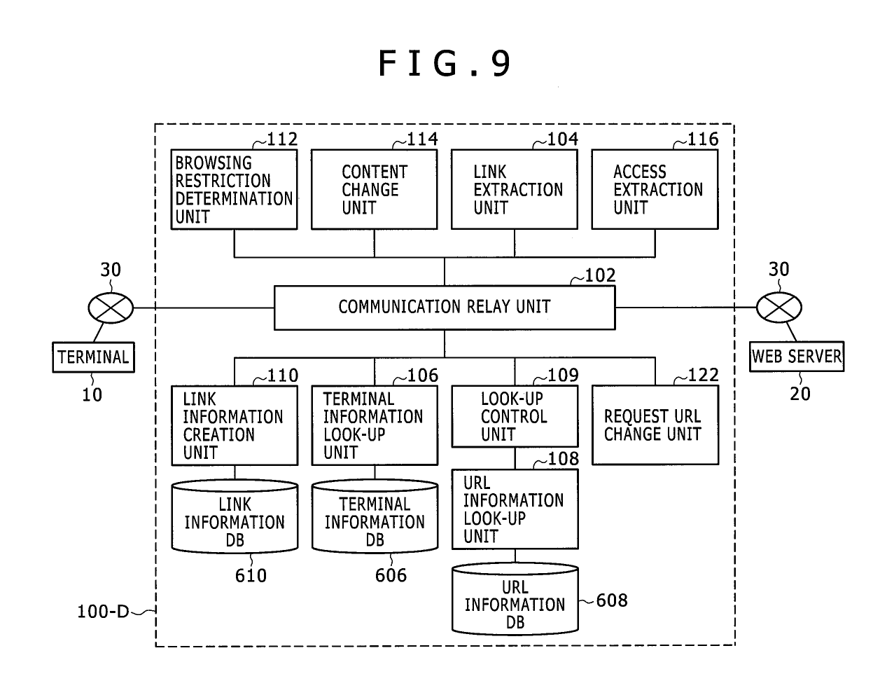

FIG. 9 shows a configuration example of a communication system according to the sixth embodiment. A relay apparatus 100-D includes a request URL change unit 122 for changing a request URL contained in a request from the terminal.

An operational flow according to this embodiment will be described. In 5118 in the first embodiment, in addition to the change of the link subject to browsing restriction, the content change unit 114 creates a new linked URL (e.g., http://a.co.jp/index.html?original) by adding a predetermined character string (e.g., “original”) as a CGI parameter to the URL of the Web page requested by the terminal, changes the Web page to display the corresponding link display e.g. at the end of the Web page, and creates new link information. The other operations are the same as in FIG. 4 in the first embodiment.

In S102 in the first embodiment, when the communication relay unit 102 receives a Web page request from the terminal 10 through the selection of the new link having the CGI parameter of the character string, the request URL change unit 122 creates a request in which the CGI parameter is eliminated from the URL of the requested Web page, and the communication relay unit 102 transmits the created request to the Web server and relays a response to the terminal as it is.

Thus, according to this embodiment, the terminal can also acquire an original Web page having links not changed by the relay apparatus. For example, in the case where the change of a link display impairs the appearance of a Web page, it is possible to browse the original Web page.

Further, this embodiment can be combined with the first to fifth embodiments.

### Seventh Embodiment

In the seventh embodiment, if link information corresponding to an acquired Web page does not exist in the cache, a relay apparatus queries another relay apparatus as to the link information.

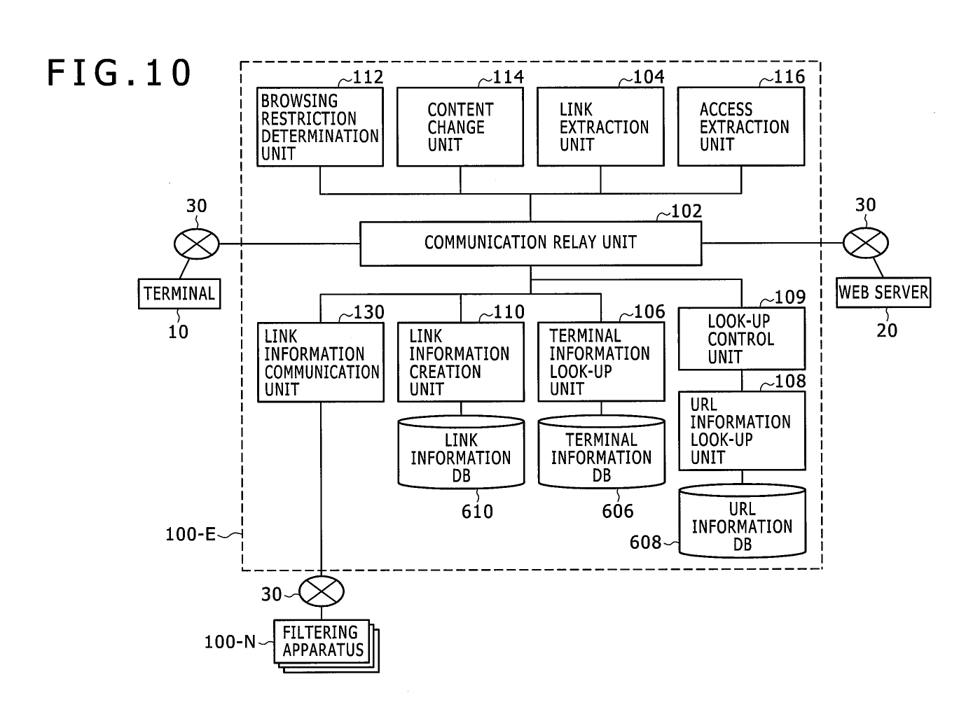

FIG. 10 shows a configuration example of a communication system according to the seventh embodiment. A relay apparatus 100-E includes a link information communication unit 130 for requesting and sending link information. The link information communication unit 130 transmits a request for link information to another relay apparatus 100-N coupled via the network 30, and receives a response. Further, the link information communication unit 130 receives a request for link information from a relay apparatus 100-N coupled via the network 30. If the requested link information exists, the link information communication unit 130 sends the link information. The link information communication unit 130 uses, for example, HTTP as a communication protocol. The other configurations are the same as in FIG. 1 in the first embodiment.

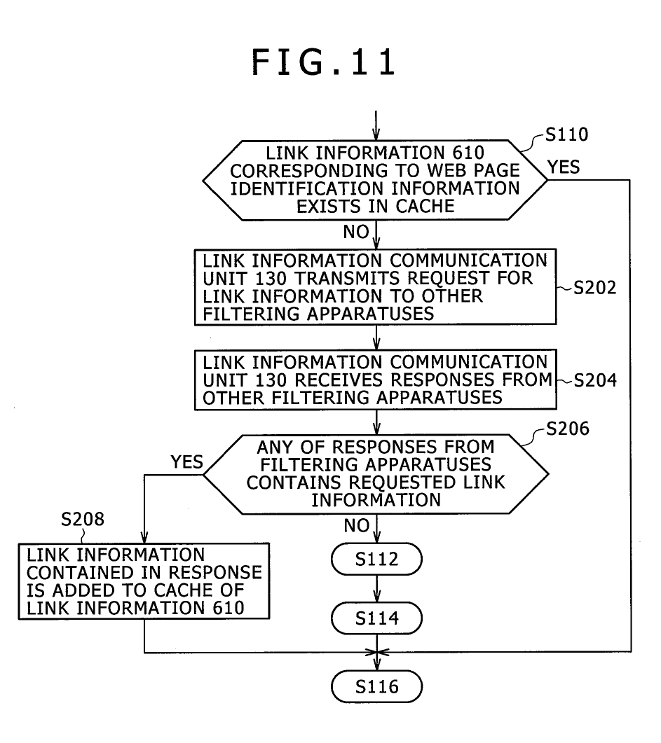

FIG. 11 is a part of a flowchart showing operations when the communication relay unit 102 of the relay apparatus 100-E receives a Web page acquisition request from the terminal 10. Operations when the communication relay unit 102 receives a Web page acquisition request from the terminal 10 are the same as those of S102 to S110 in FIG. 4 in the first embodiment. If the link information DB 610 having the page identification information about the Web page acquired in S104 does not exist in the cache (NO in S110), the link information communication unit 130 transmits a request for the link information DB 610 to another relay apparatus 100-N coupled via the network 30 (S202). The request contains the page identification information of the requested link information DB 610. An address (e.g., IP address) for identifying the relay apparatus 100-N may be stored beforehand in the relay apparatus 100-E, or may be dynamically found by querying a site for managing the address. Further, the request may be transmitted to a plurality of relay apparatuses by multicast or the like. The link information communication unit receives responses from relay apparatuses 100-N which are the destinations of the request (S204). If any of the responses contains the requested link information (YES in S206), the relay apparatus 100-E caches the link information into the link information DB 610 (S208). The other operations are the same as in FIG. 4 in the first embodiment.

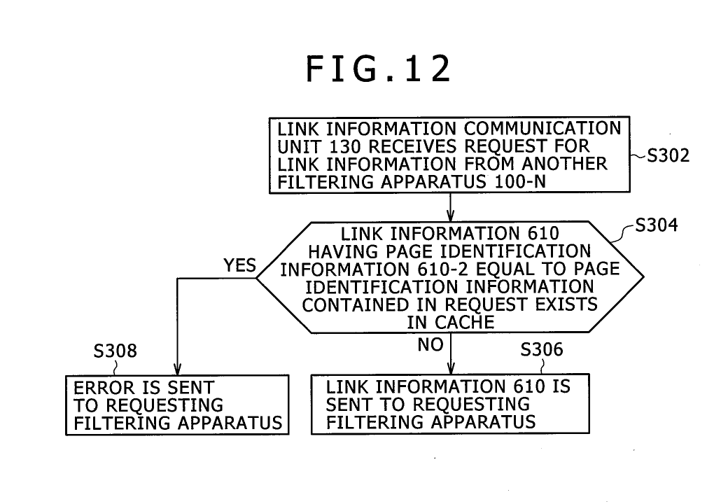

FIG. 12 is a flowchart when the link information communication unit 130 of the relay apparatus 100-E receives a request for link information from another relay apparatus 100-N. When the link information communication unit 130 receives a request for link information from a relay apparatus 100-N (S302), it is determined whether the link information DB 610 having the page identification information DB 610-2 equal to page identification information contained in the request exists (S304). If the link information DB 610 exists (YES in S304), the link information communication unit 130 sends a response containing the link information DB 610 to the requesting relay apparatus 100-N (S306). If the link information DB 610 does not exist (NO in S304), the link information communication unit 130 sends an error to the requesting relay apparatus 100-N (S308).

Thus, according to this embodiment, the relay apparatus can send to the terminal a Web page to which information about whether links in the Web page are subject to browsing restriction is added, while further suppressing a load on the URL information database by acquiring link information from another relay apparatus.

Further, this embodiment can be combined with the first to sixth embodiments.

The specification and drawings are, accordingly, to be regarded in an illustrative rather than a restrictive sense. It will, however, be evident that various modifications and changes may be made thereto without departing from the spirit and scope of the invention as set forth in the claims.

What is claimed is:

1. A Web page display method for acquiring from a server a Web page based on a request from a terminal and displaying the Web page on the terminal, the Web page display method comprising the steps of:
transmitting a Web page request to the server;
receiving the Web page from the server;
extracting a linked URL contained in the received Web page;
determining, based on a browsing restriction attribute of a linked Web page indicated by the extracted linked URL and terminal attribute information contained in the request, whether or not the linked Web page is subject to browsing restriction;
creating a determined Web page with a determination result reflected in a link display corresponding to the linked URL in the received Web page; and
displaying the determined Web page on the terminal, as a response to the Web page request.

2. The Web page display method according to claim 1, wherein a relay apparatus is provided, and performs the reception step, the extraction step, the determination step, and the creation step, and
the terminal performs the transmission step and the display step.

3. The Web page display method according to claim 2, wherein the relay apparatus performs the steps of:
creating link information indicating a location of the linked URL in the Web page from which the linked URL is extracted in the extraction step and the browsing restriction attribute of the linked Web page; and
storing the link information in association with an identifier for identifying the Web page from which the linked URL is extracted.

4. A Web page relay apparatus which is provided on a network for coupling a terminal and a server, the Web page relay apparatus comprising:
a communication relay unit for relaying a Web page request from the terminal to the server and receiving the Web page from the server;
a link extraction unit for extracting a linked URL contained in the Web page received from the server;
a URL information look-up unit for querying a URL information database for managing a browsing restriction attribute of a Web page, as to a browsing restriction attribute of a linked Web page indicated by the extracted linked URL;
a link information creation unit for creating link information indicating a location of the linked URL in the received Web page and the browsing restriction attribute of the linked Web page indicated by the linked URL based on the browsing restriction attribute acquired by the URL information look-up unit and the received Web page;
a terminal information look-up unit for extracting terminal identification information contained in the Web page request received from the terminal and querying a terminal information database for managing a combination of terminal identification information and terminal attribute information, as to a terminal attribute corresponding to the terminal identification information; and
a browsing restriction determination unit for determining, based on the terminal attribute information acquired by the terminal information look-up unit and the link information, whether the linked Web page indicated in the received Web page is subject to browsing restriction on the terminal.

5. The Web page relay apparatus according to claim 4, wherein the link information creation unit has a storage unit for storing the created link information, and
as a response to the Web page request from the terminal, if the link information corresponding to the Web page acquired from the server exists in the storage unit,
without extracting the linked URL by the link extraction unit nor querying the URL information database by the URL information look-up unit,
the browsing restriction determination unit performs the determination based on the link information stored in the storage unit and the terminal attribute information.

6. The Web page relay apparatus according to claim 5, further comprising a link information communication unit for transferring the link information to or from another relay apparatus via the network,
wherein if the link information corresponding to the Web page acquired from the server does not exist in the storage unit, using Web page identification information as a key, the link information communication unit transmits a request for the link information to the another relay apparatus and stores the requested link information contained in a received response in the storage unit, and
in the case where the link information communication unit receives a request for the link information from another relay apparatus, if the link information identified by Web page identification information contained in the request exists in the storage unit of the Web page relay apparatus, the link information communication unit transmits a response containing the link information.

7. The Web page relay apparatus according to claim 4, wherein the browsing restriction determination unit has a content change unit for creating a determined Web page with a change in an attribute of a link display corresponding to a linked URL determined to be subject to browsing restriction, and
the communication relay unit transmits to the terminal the determined Web page created by the content change unit instead of the Web page acquired from the server.

8. The Web page relay apparatus according to claim 7, wherein the content change unit creates a new linked URL by adding a predetermined character string as a CGI parameter to a URL of the Web page requested by the terminal and information for a link display corresponding to the linked URL and inserts them into the determined Web page for a response,
when the communication relay unit receives a Web page request through selection of the link display containing the CGI parameter, a request change unit eliminates the CGI parameter from the URL of the requested Web page, and
the communication relay unit relays a request changed the request change unit to the server and relays a response to the terminal as it is.

9. The Web page relay apparatus according to claim 4, wherein the terminal information database manages a level as the terminal attribute information,
the URL information database manages a level as the browsing restriction attribute, and
the browsing restriction determination unit determines based on the levels whether or not the linked Web page indicated by the linked URL contained in the Web page requested by the terminal is subject to browsing restriction.

10. The Web page relay apparatus according to claim 4, wherein the terminal information database manages a category as the terminal attribute information,
the URL information database manages a category as the browsing restriction attribute, and
the browsing restriction determination unit determines based on the categories whether or not the linked Web page indicated by the linked URL contained in the Web page requested by the terminal is subject to browsing restriction.

11. The Web page relay apparatus according to claim 4, wherein in the terminal information database, one piece of terminal identification information has at least one combination of the terminal attribute and a time, and
the terminal information look-up unit acquires a time and uses the terminal attribute corresponding to the time.

12. The Web page relay apparatus according to claim 4, wherein at least one linked URL not subject to browsing restriction is specified beforehand in a whitelist, and
the URL information look-up unit does not query a linked URL that matches any of linked URLs listed in the whitelist.

13. The Web page relay apparatus according to claim 4, wherein at least one linked URL subject to browsing restriction is specified beforehand in a blacklist, and
the URL information look-up unit does not query a linked URL that does not match any of linked URLs listed in the blacklist.

14. The Web page relay apparatus according to claim 5, further comprising a page identification information creation unit for creating Web page identification information if a response from the server does not contain the Web page identification information.
